(19) United States
(12) Patent Application Publication
(10) Pub. No.: US 2016/0094826 A1
(43) Pub. Date: Mar. 31, 2016

(54) ANALOG IMAGE ALIGNMENT

(71) Applicant: Spero Devices, Inc., Acton, MA (US)

(72) Inventors: Nihar Athreyas, Acton, MA (US); Zhiguo Lai, Acton, MA (US); Jai Gupta, Westford, MA (US); Dev V. Gupta, Concord, MA (US)

(21) Appl. No.: 14/865,454

(22) Filed: Sep. 25, 2015

Related U.S. Application Data
(60) Provisional application No. 62/084,852, filed on Nov. 26, 2014.
(60) Provisional application No. 62/056,016, filed on Sep. 26, 2014.

(51) Int. Cl. H04N 13/00

(52) U.S. Cl. CPC H04N 13/004

(57) ABSTRACT

An image processor includes an analog correlator for providing correlation information among a pair of stereo images. The image processor includes an analog-to-digital converter (ADC), an analog correlator, and a digital processor. The ADC generates digital data corresponding to analog data of a plurality of images, the digital data being stored to a memory. The analog correlator circuit calculates correlation information among the plurality of images based on the analog data. The digital processor processes the digital data based on the correlation information to provide alignment of the images.

### RELATED APPLICATIONS

This application claims the benefit of U.S. Provisional Application No. 62/084,852, filed on Nov. 26, 2014, and U.S. Provisional Application No. 62/056,016, filed on Sep. 26, 2014. The entire teachings of the above applications are incorporated herein by reference.

### BACKGROUND

Imaging technology, including image sensors and image processing circuitry, is continually evolving as it is incorporated into a greater range of devices. Wearables devices in particular, such as smart watches, headbands, and glasses, are increasingly making use of imaging capabilities. However, such devices have substantial Size, Weight and Power (SWaP) constraints. Simultaneously, efforts are being made to improve the resolution and other performance characteristics of imaging circuitry. For example, gigapixel sensors may soon find use in defense, space, and medical applications. Collecting and processing the large amounts of data from such sensors raises several challenges. At the same time, there are many emerging applications for imaging in the field of computer vision, biometric analysis, and bio-medical imaging that require ultra-high speed computations. Another growing area is the use of stereo cameras, camera arrays and light-field cameras to perform computational imaging tasks. Typical imaging architectures and digital image processing solutions may not meet the demands of these applications because they may fail to handle the high computational loads and meet the SWaP requirements simultaneously.

### SUMMARY

Example embodiments of the invention include an apparatus for processing images. In one embodiment, the apparatus includes an analog-to-digital converter (ADC), an analog correlator, and a digital processor. The ADC generates digital data corresponding to analog data of a plurality of images, the digital data being stored to a memory. The analog correlator circuit calculates correlation information among the plurality of images based on the analog data. The a digital processor can transform the plurality of images represented by the digital data, based on the correlation information, to generate an aligned image set, the digital processor further determining disparity values for the aligned image set based on the correlation information. The plurality of images may include at least two associated stereoscopic images, including a template image and a reference image.

In further embodiments, the apparatus may include a pre-processing circuit configured to generate the analog data based on input of a plurality of image sensors. The pre-processing circuit may perform a correlated double sampling (CDS) on the input of the plurality of image sensors to generate the analog data.

In still further embodiments, the analog correlator circuit may perform a normalized cross correlation (NCC) process on the analog data to provide the correlation information. The analog correlator circuit may select a subset of the analog data on which to perform the NCC process, the subset corresponding to a plurality of vectors extending across the plurality of images. The images may be divided into several blocks, and the vectors may include, for example, diagonal elements extending across the blocks. The analog correlator may also generate a moving average of the analog data during the NCC process.

In yet further embodiments, the correlator circuit can include a plurality of blocks each associated with a respective channel carrying a subset of the analog data. Each block may include a low-pass filter (LPF) receiving a channel input from the respective channel, as well as a summer configured to generate a block output based on the channel input and an output from the LPF. The blocks may be arranged in pairs, where each block of the pair receives analog data corresponding to a different one of the plurality of images. The output of each block of the pair may be combined by a combiner.

Still further embodiments of the invention include an apparatus for processing images. An analog-to-digital converter (ADC) generate digital data corresponding to analog data of a plurality of images, the digital data being stored to a memory. An analog correlator circuit calculates correlation information among the plurality of images based on the analog data. The analog correlator circuit may calculate the correlation information for a plurality of blocks each comprising a subset of one of the images, where each of the blocks has a portion common to another of the blocks. A digital processor processes the digital data based on the correlation information. The plurality of images may include at least two associated stereoscopic images, including a template image and a reference image.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating an image processor in one embodiment.

FIG. 2 is a block diagram of an image processor and including an analog correlator implementing a modified Normalized Cross Correlation (NCC) algorithm.

FIG. 3 is a flow diagram of a method of processing an image via an analog correlator implementing a modified NCC algorithm.

FIG. 4 is an illustration of a stereo image pair as processed by an analog correlator.

FIG. 5 is a chart illustrating correlation results of an image processor in one embodiment.

FIG. 6 is a block diagram of an image processor including an analog correlator in a further embodiment.

FIG. 7 is a block diagram of an image processor including an analog correlator implementing a Sum Absolute Difference (SAD)n algorithm in a still further embodiment.

FIG. 8 is a flow diagram of a method of processing an image via an analog correlator implementing a SAD algorithm.

FIG. 9 is an illustration of two overlapping image blocks resulting from applying an analog correlator implementing a SAD algorithm.

### DETAILED DESCRIPTION

A description of example embodiments of the invention follows.

Embodiments of the invention can employ analog image processing within an image processor, which may reduce SWaP and as well as reduce the computational load in the digital domain. Such analog signal processing can be implemented by interpreting the image data as a continuous stream of analog voltage values. Rather than replacing digital processing entirely, analog processing can be used to augment the digital processor and thus speed up computation.

A particular challenge in image processing, which can be addressed by analog processing, is image alignment in stereo cameras. Image pairs captured from the stereo cameras can be used for a variety of purposes, such as constructing disparity and depth maps, refocusing, and simulating the effect of optical zoom. Image alignment, which is the process of aligning common elements captured in two or more images, can be used for stitching images to create panoramas, for video stabilization, scene summarization, and other effects

An important element of stereo image processing is finding correspondence between the points in the two images that represent the same 3D point in the scene. Algorithms for finding such correspondence, referred to as stereo correspondence algorithms, have been developed. However, some of these algorithms suffer from poor performance in the presence of noise or low light. Other algorithms provide more robust performance, but may also perform slowly due to having high computational requirement. Two such stereo correspondence algorithms employ Normalized Cross Correlation (NCC) and Sum Absolute Difference (SAD), respectively. The first algorithm is a patch-based stereo correspondence algorithm and uses NCC as the similarity measure. This patch-based approach produces a coarse depth map. The second algorithm is a per-pixel algorithm, which produces a finer disparity map than the patch-based approach. Sum Absolute Differences (SAD) is used as a similarity measure in this algorithm. The first and second algorithms are referred to as the NCC algorithm and the SAD algorithm, respectively.

All stereo correspondence algorithms can be broadly classified into intensity based algorithms and feature based algorithms. If the disparity value corresponding to the best matching block is assigned to all the pixels of that block or patch, it is called a patch-based stereo correspondence algorithm. A number of intensity-based stereo correspondence algorithms have been developed for image processing. Among them, NCC is advantageous because (i) it is robust when the images being aligned have translation in the x and y direction but no rotation or shear, (ii) it is less sensitive to variation in the intensity values of two images being aligned, and (iii) it fits well into the analog architecture.

$$C ( u , v ) = \frac{{\sum }_{( x , y )} [ r ( x , y ) - {\overline{r}}_{u , v} ] [ t ( x - u , y - v ) - \overline{t} ]}{{\{ {\sum }_{( x , y )} {{[ r ( x , y ) - {\overline{r}}_{u , v} ]}^{2} [ t ( x - u , y - v ) - \overline{t} ]}^{2} \}}^{0.5}}$$

Equation (1): Implementation of the NCC Algorithm.

In the above equation, t̅_{u,v} represents the mean of the template image block and r̅_{u,v} is the mean value of the reference image present under the template image block. The denominator of the NCC equation can be calculated efficiently through the use of sum tables. However, the numerator of the NCC is still computationally intensive.

In a general NCC algorithm, the template image is divided into blocks and each block is shifted on top of the reference image. All the pixels in the block are used to perform this calculation as shown in Equation 1. In a worst-case scenario for aligning images, where there is no information available about the camera system or the scene, a brute-force approach may be used. The computational complexity in such a case would be very high. A pre-processing step that that may assist in this computation is image rectification, which essentially transforms the 2-D stereo correspondence problem to 1-D. However, the rectification process itself will add to the computational complexity of the algorithm.

In order to reduce the computational load, only the diagonal elements of the template and reference image blocks may be used to compute the correlation coefficient. One reason for this approach is that the diagonal elements of a block often have the least spatial redundancy when compared to the neighboring horizontal and vertical pixels. The modification performed on the NCC algorithm reduces the equation to Equation 2, below.

$$C ( u , v ) = \frac{{\sum }_{x} [ r ( x ) t ( x - ( u , v ) ) ] - {\overline{r}}_{u , v} {\overline{t}}_{u , v}}{{\{ {\sum }_{x} {{[ r ( x ) - {\overline{r}}_{u , v} ]}^{2} [ t ( x ( u , v ) ) - {\overline{t}}_{u , v} ]}^{2} \}}^{0.5}}$$

Equation (2): Modified NCC Algorithm.

The first term in the numerator is a 1D correlation operation, which can be implemented efficiently in analog hardware. The second term in the numerator is calculating the mean, and the denominator is calculating the variance. If implemented directly, two passes over the data are required to compute these values, which increases the computation time. This problem may be solved by introducing a further modification to the NCC algorithm. Specifically, a one-pass formula can be used to calculate the variances efficiently. We can define two quantities as shown in Equations 3 and 4:

$$\begin{matrix}{A}_{K} = \{ \begin{matrix}{x}_{1} , & k = 1 \\ {A}_{k - 1} + \frac{{x}_{k} - {A}_{k - 1}}{k} , & k = 2 , … , n\end{matrix} . & Equation ( 3 ) \\ {B}_{K} = \{ \begin{matrix}0 , & k = 1 \\ {B}_{k - 1} + \frac{( k - 1 ) {( {x}_{k} - {A}_{k - 1} )}^{2}}{k} , & k = 2 , … , n\end{matrix} . & Equation ( 4 )\end{matrix}$$

Implementing Equations 3 and 4, the variance can then be calculated as Bₙ/n.

The patch-based stereo correspondence algorithm described above, also referred to as a “modified NCC algorithm,” produces relatively coarse depth maps. This approach is suitable for applications such as navigation and people-tracking, where speed is more important than accuracy. However, in some of the other applications such as image rendering, a finer depth map may be beneficial. In these cases, a per-pixel approach of finding depth is preferred. Thus, a per-pixel stereo correspondence algorithm may be implemented, where the similarity measure used in such an algorithm is Sum of Absolute Difference (SAD). In such an embodiment, using a stride of more than one pixel can give a similar performance while significantly reducing the computational load of the image processing.

One drawback associated with a patch-based approach is that the algorithm may not perform well when there are depth discontinuities within a block. In order to obtain a finer depth estimate and reduce the effect of depth discontinuities, a series of overlapping blocks (rather than merely adjacent blocks) can be employed. For a per-pixel depth estimation, the blocks may be selected to be completely overlapping with the exception of 1 pixel (in height and/or width), meaning the “stride” is 1 pixel. However, when providing depth estimates using overlapping blocks in the digital domain, computation increases with reduction in stride as the amount of overlap between the block increases. Thus, the computational intensity of such an algorithm is higher than the patch based approach. By implementing analog signal processing, embodiments of the invention can provide per-pixel stereo correspondence while reducing computational load. Equation 5, below, shows the implementation of a SAD algorithm, where R is the reference image and T is the template image.

$$SAD ( u , v ) = {\sum }_{n = 1}^{blkHeight} {\sum }_{m = 1}^{blkWidth} \vert R ( u , v ) - T ( u + n , v + m ) \vert$$

Equation (5): Implementation of a SAD Algorithm.

Embodiments of the invention, described below, provide image processing that implements one or both of the modified NCC algorithm and the SAD algorithm described above. In general, embodiments employing the modified NCC algorithm may be beneficial for providing relatively coarse depth maps, while embodiments employing the SAD algorithm may be beneficial for providing finer depth maps. Further embodiments may also employ both algorithms in combination, as described in further detail below.

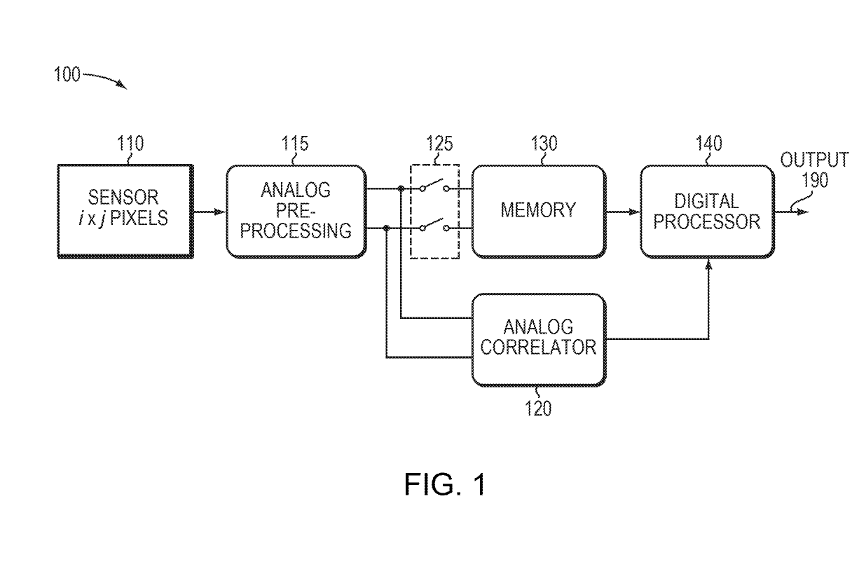

FIG. 1 is a block diagram illustrating an image processor 100 in one embodiment. The image processor 100 includes an image sensor 110, an analog pre-processing circuit 115, an analog correlator circuit 120, an analog-to-digital converter (ADC) 125, a memory 130, and a digital processor 130. The image sensor 110 may include a complementary metal-oxide semiconductor (CMOS) sensor that generates an image data output in the analog domain. The sensor 110 may, for example, capture a stereo image pair, each image having a resolution of i*j pixels. The analog pre-processing circuit 115 may perform a range of processes on the analog image data, such as image rectification. The ADC 125 converts the analog output of the pre-processing circuit 115 to digital image data, which, in turn, is stored at the memory 130. The digital processor 140 retrieves the digital image data from the memory and may perform a range of image processing in the digital domain, such as classification, pattern recognition, and projection.

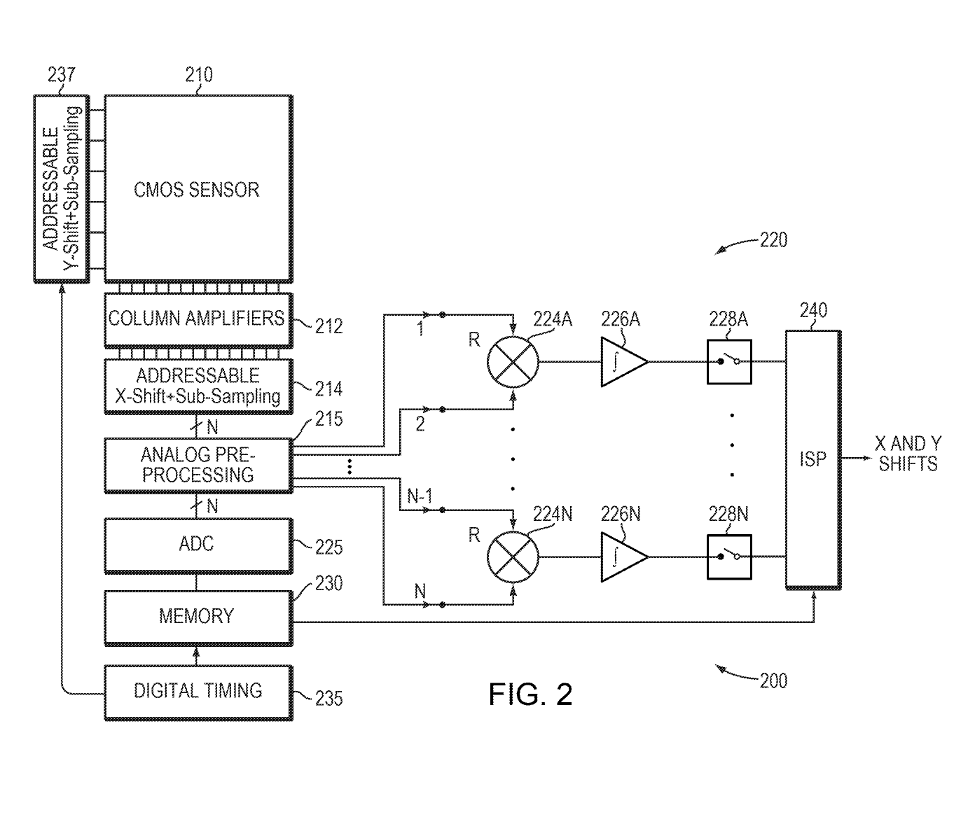

The digital processor 140 may also perform image alignment, for example by implementing one or more of the NCC and SAD algorithms described above. However, in order to reduce computational load at the digital processor 140, the analog correlator circuit 120 may perform some or all of the image alignment of the system 100 in the analog domain. In particular, the analog correlator 120 may implement one or both of the modified NCC algorithm and the SAD algorithm described above. Example embodiments of an analog correlator implementing such algorithms are described in further detail below with reference to FIGS. 2-9.

Thus, in the image processor 100, a digital system (ADC 125, memory 130, digital processor 140) accesses the sensor 110 and operates to digitize, store, and process the captured images in the digital domain. Further, a parallel analog system (analog correlator circuit 120) accesses the analog data from the sensor 110, processes it to provide image alignment information, and then provides such information to the digital processor for further computations. In this hybrid digital-analog system, the analog block is performing the computationally-intensive task of running the modified NCC and/or SAD algorithms as the image data is being read off the image sensor 110. Further, the analog correlator 120 may be configured in the control plane, rather than in the signal plane. A common disadvantage of an analog system is the noise that it typically introduces. However, in system 100, the analog correlator 120 is not responsible for signal acquisition, and hence the problem of signal being corrupted by noise may be prevented.

FIG. 2 is a block diagram of an image processor 200 including an analog correlator circuit 220 implementing a modified Normalized Cross Correlation (NCC) algorithm. The processor 200 may be configured to include features of the image processor 100 as described above with reference to FIG. 1. In particular, the processor 200 includes an image sensor 210, an analog pre-processing circuit 215, an analog correlator circuit 220, an analog-to-digital converter (ADC) 225, a memory 230, and an image signal processor (ISP) (e.g., a digital processor) 240. The processor 200 may further include readout circuitry, including column amplifiers 212 configured to amplify output of the image sensor 210, as well as X/Y-shift and sub-sampling circuits 214, 237, and a digital timing circuit 235, which may provide further processing of the image data.

Referring again to the modified NCC algorithm (Equation (2), above), the first term in the numerator of represents a 1D correlation operation. The output of the image sensor 210 comprises N analog channels, which read the analog data from the sensor directly. These N analog channels can be grouped into pairs in which one channel is used to read the reference image data and the other channel is used to read template image data (e.g., of a stereo image pair). The image sensor 210 is capable of accessing individual pixel data. The readout circuitry 212, 214, 237 may be used to selectively read the diagonal elements of the template and reference image blocks. The analog pre-processing circuit 215 provides the analog image data that may be implemented by the analog correlator circuit 220 to perform the NCC algorithm.

The analog correlator circuit 220 includes a plurality of units, each of which operates in parallel on a respective N analog channel pair. Each unit comprises a multiplier 224A-N, an integrator 226A-N, and an ADC 228A-N connected in series. The multiplier 224A-N and integrator 226A-N together perform the correlation operation as defined in the modified NCC algorithm. The outputs of each integrator 226A-N are then digitized by the respective ADC 228A-N and sent to the ISP 240 for further processing. The ISP 240 can calculate the numerator of the NCC algorithm. For calculating the denominator and other numerator terms, the one-pass method described above, with reference to equations (3) and (4), can be used. Such calculations can be completed efficiently in the digital domain by the ISP 240 following the correlation performed by the analog correlator circuit 220. Based on the correlation information provided by the correlator circuit 220, the ISP 240 can determine disparity values (e.g., X and Y shifts) among the image pair. In turn, the ISP 240 (or a further processor) can employ the disparity values to shift the blocks of the images accordingly, resulting in an aligned image pair.

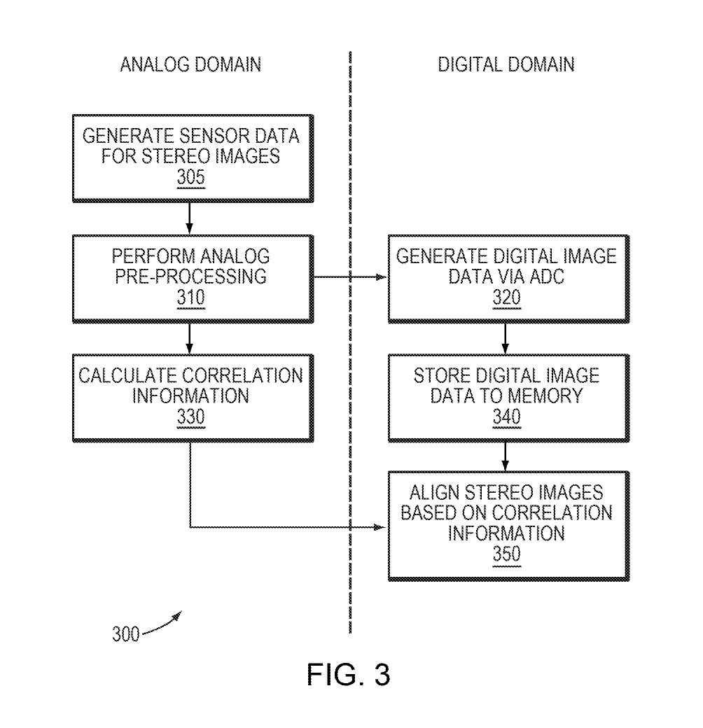

FIG. 3 is a flow diagram of a process 300 for processing a stereo image pair via an analog correlator implementing a modified NCC algorithm. The process 300 may be implemented, for example, by the image processors 100, 200 described above with reference to FIGS. 1 and 2. The elements of the process 300 occur either in the analog domain (at left) or in the digital domain (at right). Referring to FIG. 2, for example, the image sensor 210 may generate analog image data for a stereo image pair (305). An analog pre-processing circuit 215 may then perform pre-processing in the analog domain, and output pre-processed analog image data (310). This data is received by the ADC 225 to generate digital image data (320) and store the digital image data to the memory 230. The analog image data is also received by the analog correlator circuit 220, which calculates correlation information for the image pair in the analog domain (330). The ISP 240 receives both the digital image data from the memory 230 and the correlation information (converted to the digital domain) from the analog correlator circuit 220. Based on the correlation information, the ISP performs image alignment on the stereo image pair (350).

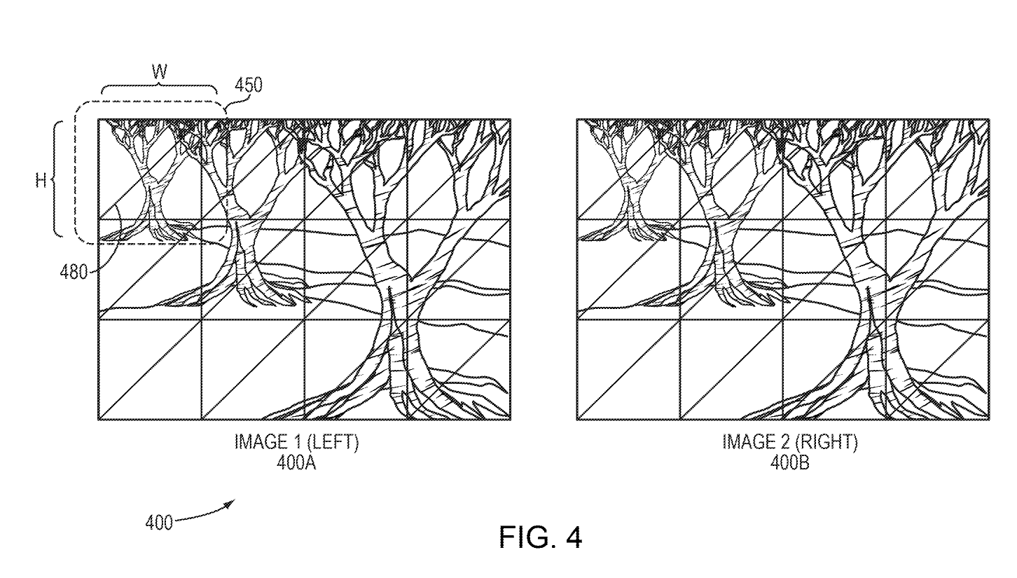

FIG. 4 is an illustration of a stereo image pair 400A-B as processed by an analog correlator. The image pair 400A-B may be captured, for example, by the image sensors 110, 210 described above with reference to FIGS. 1 and 2. Image 1 400A is a “left” image of the stereo pair, while image 2 400B is the “right” image of the stereo pair. When processed by an image processor such as the image processors 100, 200 described above, each image 400A-B is divided into a plurality of blocks, each block (e.g., block 450) having a width of W pixels and a height of H pixels. Example block sizes that may be implemented in the image processors include block sizes of 5×5, 7×7, 11×11 and 15×15 pixels. Further, each block includes a vector (e.g., vector 480) extending diagonally across the block, from the lower left corner to the upper right corner. This diagonal element, as described above, may be isolated for analysis by the analog image correlator (e.g., analog correlator circuits 120, 220) in order to reduce computational load. For many images, diagonal elements of a block often have the least spatial redundancy when compared to the neighboring horizontal and vertical pixels, and therefore provide sufficient information for image correlation under many conditions.

Embodiments of the invention implementing the modified NCC algorithm (e.g., the image processor 200 described above with reference to FIG. 2) can be measured for performance under a number of metrics, including the correlation coefficient. These metrics can be compared against the metrics generated by the original algorithm (e.g., a NCC algorithm implemented in the digital domain) to show that the modified algorithm is faster and has a performance similar to that of the original algorithm.

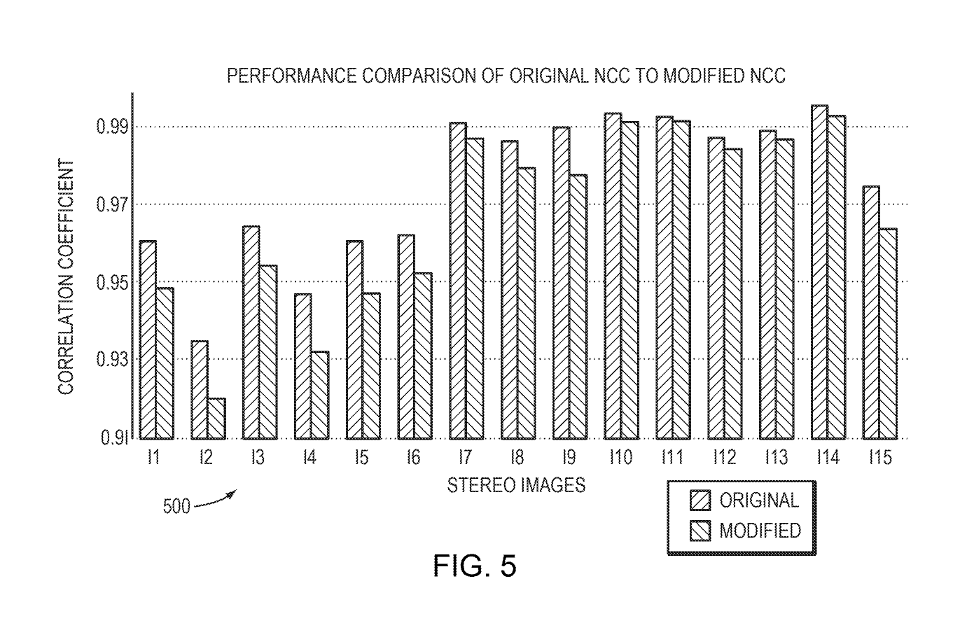

FIG. 5 is a chart illustrating correlation results of an image processor implementing the modified NCC algorithm in one embodiment. Specifically, FIG. 5 provides a comparison of the correlation coefficients obtained for 15 stereo image pairs (I1-i15) by using the original NCC algorithm (at left) and the modified NCC algorithm (at right). As can be seen, the performance of an embodiment implementing the modified NCC algorithm is very close to that of the original NCC algorithm. Further, a notable increase in speed of run time (e.g., 2X) was observed for the modified NCC algorithm over the original algorithm, due in part to the modification of the algorithm as described above.

The image processor 200, described above with reference to FIG. 2, may be configured to provide comparable performance as shown in FIG. 5. Further, embodiments of the present invention can provide robust performance in the presence of noise. Despite the inclusion of analog circuit elements, including for example multipliers 224A-N and integrators 226A-N as described above, when noise is added to the system, the resulting correlation coefficients are only minimally effected. Thus, embodiments implementing the modified NCC algorithm, such as the image processor 200, can provide stable performance in the presence of added noise by the analog circuitry.

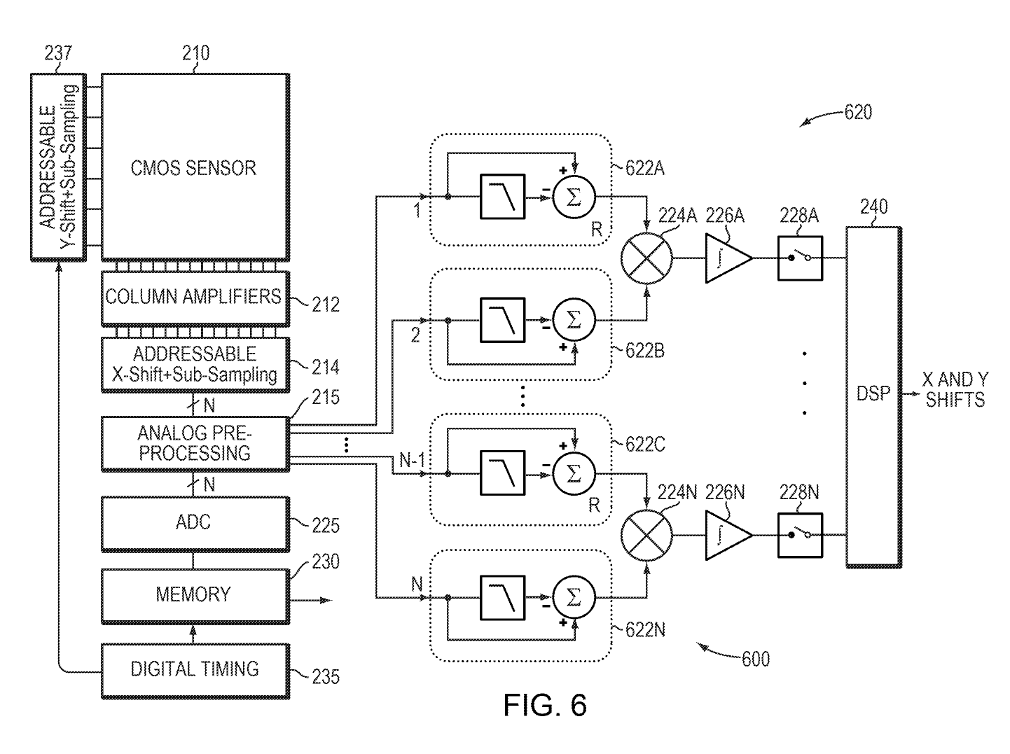

FIG. 6 is a block diagram of an image processor 600 including an analog correlator circuit 620 implementing a modified Normalized Cross Correlation (NCC) algorithm. The processor 600 may be configured to include features of the image processors 100, 200 as described above with reference to FIGS. 1 and 2. In particular, the processor 600 may include a number of the same elements of the image processor 200 of FIG. 2, including an image sensor 210, an analog pre-processing circuit 215, an analog-to-digital converter (ADC) 225, a memory 230, and an image signal processor (ISP) (e.g., a digital processor) 240. The processor 200 may further include readout circuitry, including column amplifiers 212 configured to amplify output of the image sensor 210, as well as X/Y-shift and sub-sampling circuits 214, 237, and a digital timing circuit 235, which may provide further processing of the image data. The processor 600 differs from the processor 200 of FIG. 2 via the analog correlator circuit 620, which is described in further detail below.

The analog correlator circuit 620 includes a plurality of units, each of which operates in parallel on a respective N analog channel pair. Each unit comprises a pair of sub-units 622A-N (each unit comprising a low-pass filter (LPF) and a summer connected in series), a multiplier 224A-N, an integrator 226A-N, and an ADC 228A-N connected in series. The sub-units 622A-N enable a further modification to the NCC algorithm. At each sub-unit 622A-N, the LPF provides a moving average rather than a regular average, and the moving average is subtracted from the original signal via the summer.

The multiplier 224A-N and integrator 226A-N together perform the correlation operation as defined in the modified NCC algorithm. The outputs of each integrator 226A-N are then digitized by the respective ADC 228A-N and sent to the ISP 240 for further processing. The ISP 240 can calculate the numerator of the NCC algorithm. For calculating the denominator and other numerator terms, the one-pass method described above, with reference to equations (3) and (4), can be used. Such calculations can be completed efficiently in the digital domain by the ISP 240 following the correlation performed by the analog correlator circuit 220.

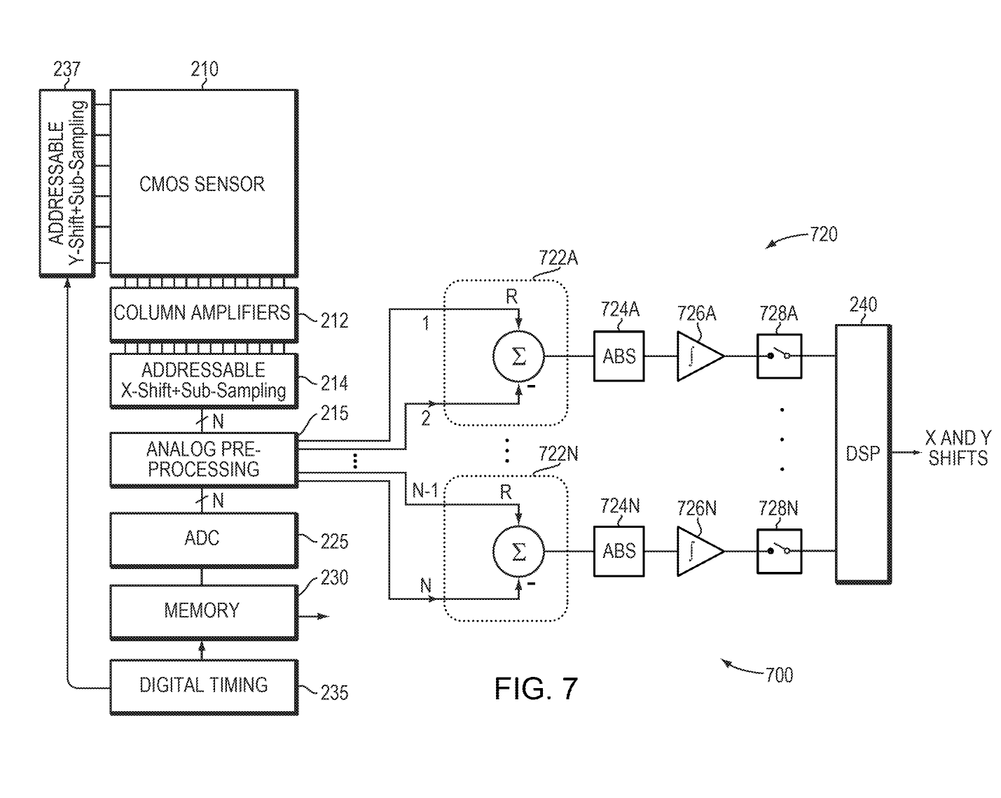

FIG. 7 is a block diagram of an image processor 700 including an analog correlator implementing the Sum Absolute Difference (SAD) algorithm as described above with reference to equation (5). The processor 700 may be configured to include features of the image processors 100, 200, 600 as described above with reference to FIGS. 1, 2 and 6. In particular, the processor 700 may include a number of the same elements of the image processor 200 of FIG. 2, including an image sensor 210, an analog pre-processing circuit 215, an analog-to-digital converter (ADC) 225, a memory 230, and an image signal processor (ISP) (e.g., a digital processor) 240. The processor 200 may further include readout circuitry, including column amplifiers 212 configured to amplify output of the image sensor 210, as well as X/Y-shift and sub-sampling circuits 214, 237, and a digital timing circuit 235, which may provide further processing of the image data.

The processor 700 differs from the processor 200 of FIG. 2 via the analog correlator circuit 720. The analog correlator circuit 720 includes a plurality of units, each of which operates in parallel on a respective N analog channel pair. Each unit comprises a summer 722A-N, an absolute value (ABS) circuit 724A-N, an integrator 726A-N, and an ADC 728A-N connected in series.

The analog correlator circuit 720 receives N analog channels, of which the odd-numbered channels are reading the reference image data, and the even-numbered channels are reading the template image data. In order to increase computation speed, the entire rows or columns of the reference and template image data may be read at once and their difference is calculated via the summer 722A-N at each analog channel pair. This data is then passed through the respective ABS circuit 724A-N and then through the respective integrator 726A-N. The integrator 726A-N accomplishes a 1D summation, and the integrator output is sampled by the respective ADC 728A-D at a particular rate depending on the size of the window/block. These values are then fed into the DSP 240, where the second-dimensional summation may be performed, along with any further processing and that is required.

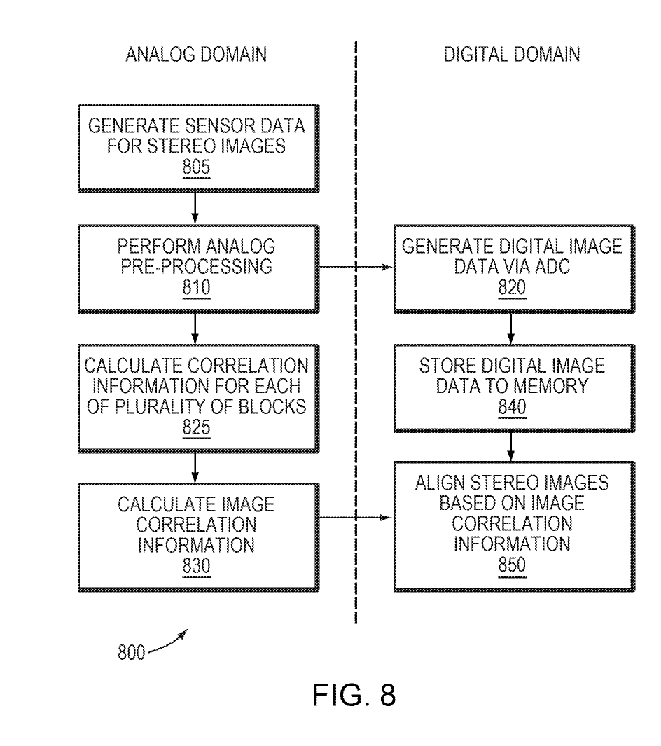

FIG. 8 is a flow diagram of a method of processing an image via an analog correlator implementing a SAD algorithm. The process 800 may be implemented, for example, by the image processors 100, 700 described above with reference to FIGS. 1 and 7. The elements of the process 300 occur either in the analog domain (at left) or in the digital domain (at right). Referring to FIG. 7, for example, the image sensor 210 may generate analog image data for a stereo image pair (805). An analog pre-processing circuit 215 may then perform pre-processing in the analog domain, and output pre-processed analog image data (810). This data is received by the ADC 225 to generate digital image data (820) and store the digital image data to the memory 230. The analog image data is also received by the analog correlator circuit 720, which calculates correlation information for each of the plurality of blocks comprising the image pair in the analog domain (825), and, based on this block correlation information, may further calculate correlation information among the pair of images (830). The ISP 240 receives both the digital image data from the memory 230 and the correlation information (converted to the digital domain) from the analog correlator circuit 220. Based on the correlation information, the ISP performs image alignment on the stereo image pair (850).

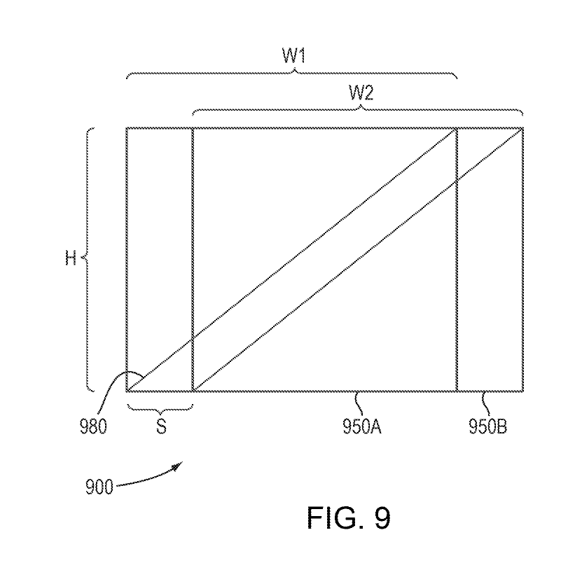

FIG. 9 is an illustration of two overlapping image blocks 950A-B resulting from applying an analog correlator implementing a SAD modified NCC algorithm. Each of the blocks 950A-B has identical dimensions and a diagonal element (e.g., diagonal element 980); however, the second image 950B is shifted rightward from the first image 950A by a measure of S pixels. Referring to FIG. 7, the image processor 700 enables a varying overlap of blocks that are analyzed for image correlation. The amount of overlap determines the accuracy to which the depth or disparity can be obtained.

Further embodiments of the invention may implement both the modified NCC algorithm (as described above with reference to FIG. 2) and the SAD algorithm (as described above with reference to FIG. 7). Such a combination may be implemented in the analog domain, for example by combining elements of the analog correlator circuit 220 of FIG. 2 and the analog correlator circuit 720 of FIG. 7. In particular, the analog correlator circuits 220, 720 may be connected in series, where the output of the series is forwarded to the ISP 240 to provide correlation information. Alternatively, some of the correlation calculations may be completed in the digital domain, such as by the ISP 240. For example, in the image processor 200 of FIG. 2, the analog correlator circuit 220 may implement the modified NCC algorithm as shown to produce relatively coarse correlation information. The ISP 240, receiving this information, may further perform a SAD algorithm to provide finer correlation information. Such an implementation provides flexibility as it allows a portion of the correlation calculations to be reconfigured in the digital domain as necessary. For example, the SAD algorithm can be selectively enabled in the digital domain to provide finer correlation information when required by a given imaging application. The block-based NCC process performs a coarse image alignment which precedes per-pixel image alignment, of which SAD is an example, reducing the computation time of the per-pixel image alignment process.

Embodiments of the invention, as described above, provide a number of advantages over previous image processing techniques. By employing analog image processing within an image processor, size, weight and power (SWaP) attributes of the image processor can be minimized, and the computational load in the digital domain can be greatly reduced. Rather than replacing digital processing entirely, analog processing can be used to augment the digital processor and thus speed up computation.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for processing images, comprising:
an analog-to-digital converter (ADC) configured to generate digital data corresponding to analog data of a plurality of images, the digital data being stored to a memory;
an analog correlator circuit configured to calculate correlation information among the plurality of images based on the analog data; and
a digital processor configured to transform the plurality of images represented by the digital data, based on the correlation information, to generate an aligned image set, the digital processor further determining disparity values for the aligned image set based on the correlation information.

2. The apparatus of claim 1, wherein the plurality of images includes at least two associated stereoscopic images, the stereoscopic images including a template image and a reference image.

3. The apparatus of claim 1, further including a pre-processing circuit configured to generate the analog data based on input of a plurality of image sensors.

4. The apparatus of claim 3, wherein the pre-processing circuit performs a correlated double sampling (CDS) on the input of the plurality of image sensors to generate the analog data.

5. The apparatus of claim 1, wherein the analog correlator circuit is further configured to perform a normalized cross correlation (NCC) process on the analog data to provide the correlation information.

6. The apparatus of claim 5, wherein the analog correlator circuit is further configured to perform a sum absolute difference (SAD) process on the analog data to provide the correlation information, the analog correlator performing the SAD process in series with the NCC process.

7. The apparatus of claim 5, wherein the analog correlator circuit is further configured to select a subset of the analog data on which to perform the NCC process, the subset corresponding to a plurality of vectors extending across the plurality of images.

8. The apparatus of claim 7, wherein each of the plurality of images are divided into respective blocks, the plurality of vectors include diagonal elements extending across the blocks.

9. The apparatus of claim 5, wherein the analog correlator circuit is further configured to generate a moving average of the analog data during the NCC process.

10. The apparatus of claim 1, wherein the analog correlator circuit includes a plurality of blocks each associated with a respective channel carrying a subset of the analog data.

11. The apparatus of claim 10, wherein each of the plurality of blocks includes:
a multiplier receiving a signal pair from the respective channel; and
an integrator configured to integrate the output of the multiplier.

12. The apparatus of claim 1, wherein the analog correlator circuit performs a normalized cross correlation (NCC) process on the analog data to provide the correlation information for a coarse image alignments, and wherein the digital processor is further configured to perform a sum absolute difference (SAD) process, based on the correlation information, to perform a per-pixel image alignment, the digital processor transforming the plurality of images based on the SAD process.

13. A method of processing images, comprising:
generating digital data corresponding to analog data of a plurality of images, the digital data being stored to a memory;
calculating, in an analog domain, correlation information among the plurality of images based on the analog data; and
transforming the plurality of images represented by the digital data, based on the correlation information, to generate an aligned image set; and
determining disparity values for the aligned image set based on the correlation information.

14. An apparatus for processing images, comprising:
an analog-to-digital converter (ADC) configured to generate digital data corresponding to analog data of a plurality of images, the digital data being stored to a memory;
an analog correlator circuit configured to calculate correlation information among the plurality of images based on the analog data, the analog correlator circuit calculating the correlation information for a plurality of blocks each comprising a subset of one of the plurality of images, each of the plurality of blocks having a portion common to another of the plurality of blocks; and
a digital processor configured to transform the plurality of images represented by the digital data, based on the correlation information, to generate an aligned image set, the digital processor further determining disparity values for the aligned image set based on the correlation information.

15. The apparatus of claim 14, wherein the plurality of images includes at least two associated stereoscopic images, the stereoscopic images including a template image and a reference image.

16. The apparatus of claim 14, further including a pre-processing circuit configured to generate the analog data based on input of a plurality of image sensors.

17. The apparatus of claim 16, wherein the pre-processing circuit performs a correlated double sampling (CDS) on the input of the plurality of image sensors to generate the analog data.

18. The apparatus of claim 14, wherein each of the plurality of blocks is distinguished from another of the plurality of blocks by at least one of a single row and a single column of pixels.

19. The apparatus of claim 14, wherein the analog correlator circuit includes a plurality of blocks each associated with a respective channel carrying a subset of the analog data.

20. The apparatus of claim 19, wherein each of the plurality of blocks includes:
a summer receiving a signal pair from the respective channel;
an absolute value (ABS) circuit connected to an output of the summer; and
an integrator connected to an output of the ABS circuit.

21. The apparatus of claim 14, wherein the analog correlator circuit is further configured to perform a sum absolute difference (SAD) process on the analog data to provide the correlation information.

22. The apparatus of claim 21, wherein the analog correlator circuit is further configured to perform a normalized cross correlation (NCC) process on the analog data to provide the correlation information for a coarse image alignment, the analog correlator performing the NCC process in series with the SAD process to provide the correlation information for a per-pixel image alignment.

23. A method of processing images, comprising:
generating digital data corresponding to analog data of a plurality of images, the digital data being stored to a memory;
calculating, in an analog domain, correlation information for a plurality of blocks each comprising a subset of one of the plurality of images, each of the plurality of blocks having a portion common to another of the plurality of blocks;
calculating, in an analog domain, correlation information among the plurality of images based on the correlation information for the plurality of blocks; and
transforming the plurality of images represented by the digital data, based on the correlation information, to generate an aligned image set; and
determining disparity values for the aligned image set based on the correlation information.

24. The method of claim 23, wherein each of the plurality of blocks is distinguished from another of the plurality of blocks by at least one of a single row and a single column of pixels.

25. The method of claim 23, wherein the plurality of blocks includes a first block and a second block, and further comprising:
defining the first block as a first subset of one of the plurality of images; and
defining the second block as a second subset of the one of the plurality of images, the second subset being shifted from the first subset by at least one of a single row and a single column of pixels.
